(19) United States
(12) Patent Application Publication
(10) Pub. No.: US 2024/0104923 A1
(43) Pub. Date: Mar. 28, 2024

(54) FOCUS DETERMINATION DEVICE, IRIS AUTHENTICATION DEVICE, FOCUS DETERMINATION METHOD, AND RECORDING MEDIUM

(71) Applicant: NEC CORPORATION, Minato-ku, Tokyo (JP)

(72) Inventors: Ryuichi AKASHI, Tokyo (JP); Takahiro TOIZUMI, Tokyo (JP)

(73) Assignee: NEC CORPORATION, Minato-ku, Tokyo (JP)

(21) Appl. No.: 17/768,562

(22) PCT Filed: Sep. 15, 2020
(86) PCT No.: PCT/JP2020/034887

§ 371 Date: Apr. 13, 2022

(51) Int. Cl. G06V 10/98; G06V 10/60; G06V 40/18; G06V 40/19

(52) U.S. Cl. CPC G06V 10/993; G06V 10/60; G06V 40/19; G06V 40/193; G06V 40/197

(57) ABSTRACT

In a focus determination device, an acquisition acquires an iris image including an iris of a user. A filter processing unit performs a filter processing by applying an image processing filter in a shape decided based on a shape of a light applied to the user to the iris image. A focus determination unit determines whether or not the iris image is in focus based on the iris image resulting from the filter processing.

### TECHNICAL FIELD

The present disclosure relates to processing of an iris image.

### BACKGROUND ART

As one kind of biometric authentication, iris authentication has been known. Generally, in iris authentication, an iris pattern of a user is registered in a database. At the time of authentication, an iris pattern acquired from a user is collated with the iris pattern registered in the database, and the authentication is thereby performed.

Since a fine pattern of an iris is used for registration and authentication of an iris, iris information has to be extracted from an image in which an iris is in focus. In order to avoid extraction of the iris information from an image in which an iris is out of focus, it is desirable to determine whether or not the photographed image is focused on the iris before the registration or authentication process of an iris is performed. Further, in view of a calculation amount, it is desirable to perform a focus determination in advance because an extraction process of the iris information from an image in which an iris is out of focus can be omitted. Patent Document 1 discloses a procedure to determine whether or not an iris image is in focus by using edge strength of an iris region.

### PRECEDING TECHNICAL REFERENCES

### Patent Document

Patent Document 1: Japanese Patent Application Laid-Open No. 2008-090483

### SUMMARY

### Problem to be Solved by the Invention

In the procedure of Patent Document 1, a focus determination is performed by using an edge of an iris region of a photographed image. However, unless the photographed image is in focus to some extent, the edge of the iris region may not be correctly detected and the focus determination may not be performed.

One object of the present disclosure is to provide a focus determination device capable of precisely performing a focus determination for plural iris images.

### Means for Solving the Problem

According to one aspect of the present disclosure, there is provided a focus determination device comprising:
an acquisition unit configured to acquire an iris image including an iris of a user;
a filter processing unit configured to perform a filter processing by applying an image processing filter in a shape decided based on a shape of a light applied to the user to the iris image; and
a focus determination unit configured to determine whether or not the iris image is in focus based on the iris image resulting from the filter processing.

According to another aspect of the present disclosure, there is provided a focus determination method comprising:
acquiring an iris image including an iris of a user;
performing a filter processing by applying an image processing filter in a shape decided based on a shape of a light irradiated to the user to the iris image; and
determining whether or not the iris image is in focus based on the iris image resulting from the filter processing.

According to still another aspect of the present disclosure, there is provided a recording medium recording a program causing a computer to execute the processes of:
acquiring an iris image including an iris of a user;
performing a filter processing by applying an image processing filter in a shape decided based on a shape of a light irradiated to the user to the iris image; and
determining whether or not the iris image is in focus based on the iris image resulting from the filter processing.

### BRIEF DESCRIPTION OF THE DRAWINGS

FIGS. 1A and 1B illustrate an example of an imaging device for an iris image.

FIG. 2 illustrates an example of a focus determination device according to a first example embodiment.

FIG. 3 illustrates a hardware configuration of the focus determination device according to the first example embodiment.

FIG. 4 illustrates a functional configuration of the focus determination device according to the first example embodiment.

FIGS. 5A and 5B illustrate an example of a light and an example of a reflection region of the light in an iris image.

FIGS. 6A and 6B illustrate examples of an image processing filter.

FIG. 7 is a flowchart of a focus determination process of the first example embodiment.

FIG. 8 illustrates a functional configuration of a focus determination device according to a ninth example embodiment.

FIG. 9 is a flowchart of a focus determination process of the ninth example embodiment.

FIG. 10 illustrates a functional configuration of an iris authentication device according to a tenth example embodiment.

FIG. 11 illustrates a functional configuration of an iris authentication device according to an eleventh example embodiment.

FIGS. 12A and 12B illustrate selection examples of iris images in the eleventh example embodiment and a twelfth example embodiment.

FIG. 13 illustrates a functional configuration of an iris authentication device according to a thirteenth example embodiment.

FIG. 14 illustrates a functional configuration of a focus determination device according to a fourteenth example embodiment.

FIG. 15 is a flowchart of a focus determination process of the fourteenth example embodiment.

### EXAMPLE EMBODIMENTS

Preferable example embodiments of the present disclosure will hereinafter be described with reference to drawings.

### First Example Embodiment

[Imaging Device]

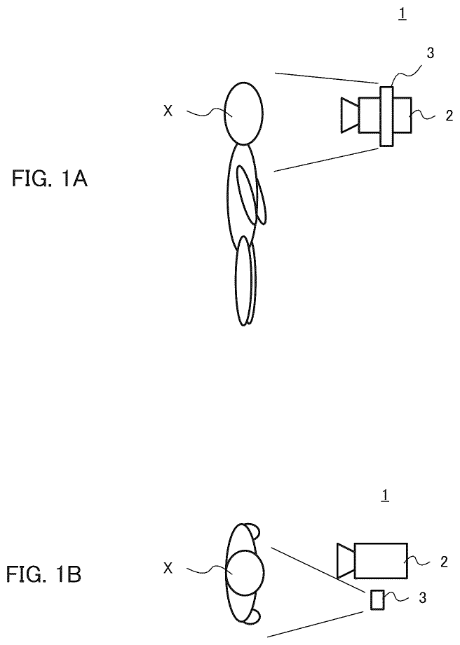

FIG. 1 illustrates an example of an imaging device for an iris image. FIG. 1A is a diagram in which a user X and an imaging device 1 are seen from a lateral side, and FIG. 1B is a diagram in which the user X and the imaging device 1 are seen from above. The imaging device 1 includes a camera 2 and a light 3 and takes an iris image of the user X. The light 3 is arranged in the vicinity of the camera 2. Note that in FIG. 1A, the light 3 is arranged on a front side of the camera 2. In the example of FIG. 1, a linear light source is used as the light 3, but a shape of the light 3 is not limited to a linear shape. Further, the light 3 may be integrated with the camera 2 and may be installed independently from the camera 2.

When the iris image is taken, the user X stands in front of the camera 2. In a state where the face of the user X is illuminated by the light 3, the camera 2 images the region around the face of the user. Note that an imaging range of the camera 2 may be the whole face of the user X or may be only a part around an eye of the user X. Among the images taken by the camera 2, an image of an eye region of the user X is used as the iris image. Therefore, in a case where the imaging range of the camera 2 is wider than the eye region of the user X, the eye region is cut out from the taken image and is used as the iris image.

[Focus Determination Device]

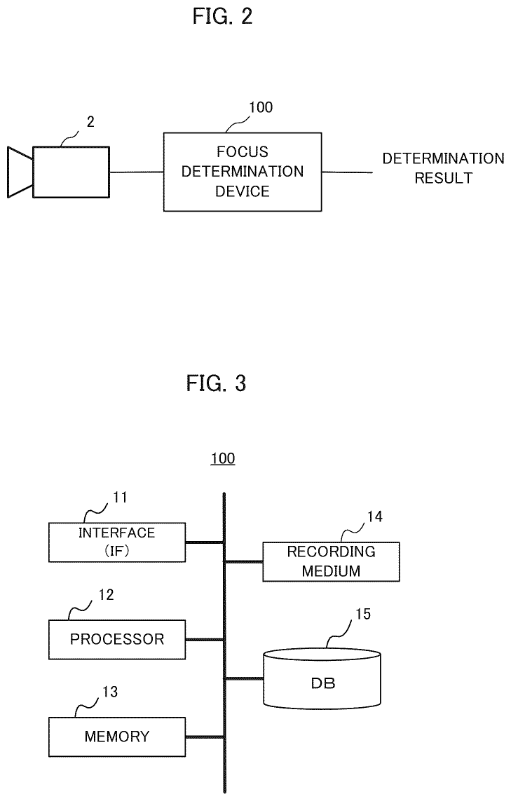

FIG. 2 illustrates an example a focus determination device. A focus determination device 100 is connected with the camera 2 and acquires the iris image from the camera 2. The focus determination device 100 performs a determination of whether or not the acquired iris image is in focus (hereinafter, referred to as “focus determination”). Note that a state where an image is in focus will also be referred to as “focused state”, and a state where an image is out of focus will also be referred to as “unfocused state”.

(Hardware Configuration) FIG. 3 is a block diagram illustrating a hardware configuration of the focus determination device 100. As illustrated in FIG. 3, the focus determination device 100 includes an interface (IF) 11, a processor 12, a memory 13, a recording medium 14, and a database (DB) 15.

The IF 11 performs inputs and outputs with an external device. Specifically, the iris image of the user X is inputted to the focus determination device 100 via the IF 11. Further, a determination result by the focus determination device 100 is outputted to an external device through the IF 11.

The processor 12 is a computer such as a CPU (Central Processing Unit), and executes a program prepared in advance thereby to control the whole focus determination device 100. Note that as the processor 12, one of a CPU, a GPU (Graphics Processing Unit), an FPGA (Field-Programmable Gate Array), a DSP Demand-Side Platform), and an ASIC (Application Specific Integrated Circuit) may be used, or plural processors may be used in parallel. Specifically, the processor 12 executes a focus determination process described later.

The memory 13 is configured with a ROM (Read-Only Memory), a RAM (Random Access Memory), and so forth. The memory 13 is also used as a working memory during execution of various processes by the processor 12.

The recording medium 14 is a non-volatile and non-transitory recording medium such as a disk-type recording medium or a semiconductor memory and is configured to be detachable from the focus determination device 100. The recording medium 14 records various programs to be executed by the processor 12. When the focus determination device 100 executes the focus determination process, a program recorded in the recording medium 14 is loaded to the memory 13 and is executed by the processor 12.

The database 15 temporarily stores the iris image inputted through the IF 11, a focus determination result by the focus determination device 100, and so forth. Note that in a case where the memory 13 has a sufficient storage capacity for those sets of data, the database 15 may be omitted. Further, the focus determination device 100 may include input units such as a keyboard and a mouse and a display unit such as a liquid crystal display, by which an administrator or the like performs instructions and inputs.

[Functional Configuration]

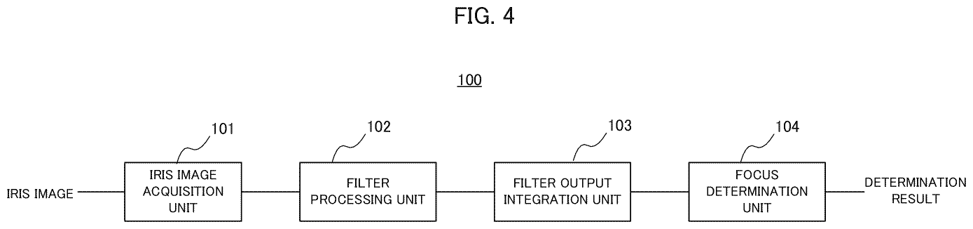

FIG. 4 is a block diagram illustrating a functional configuration of the focus determination device 100. The focus determination device 100 functionally includes an iris image acquisition unit 101, a filter processing unit 102, a filter output integration unit 103, and a focus determination unit 104.

The iris image acquisition unit 101 acquires the iris image from the camera 2 or the like illustrated in FIGS. 1A and 1B. Note that the iris image acquisition unit 101 may acquire the iris image from a database or a recording medium which stores the iris images already taken, instead of directly acquiring the iris image from the camera 2.

The filter processing unit 102 executes filter processing for the focus determination. Specifically, the filter processing unit 102 applies an image processing filter of the shape decided based on the shape of the light 3 illustrated as an example in FIGS. 1A and 1B to the iris image and thereby performs the filter processing. When an iris is imaged, as illustrated in the imaging device 1 in FIGS. 1A and 1B, the iris of the user is illuminated by the light 3. As the light, a visible light or a near infrared light is used. The iris image taken includes the reflection of the light 3. Accordingly, in the present example embodiment, the focus determination of the iris image is performed by using the reflection of the light 3 included the iris image. Specifically, an image processing filter which has the shape decided based on the shape of the light 3 is prepared in advance. The image processing filter prepared in advance is a versatile image processing filter which is used for plural iris images. The filter processing unit 102 performs the filter processing by applying this image processing filter to the iris image and outputs the iris image resulting from the filter processing to the filter output integration unit 103.

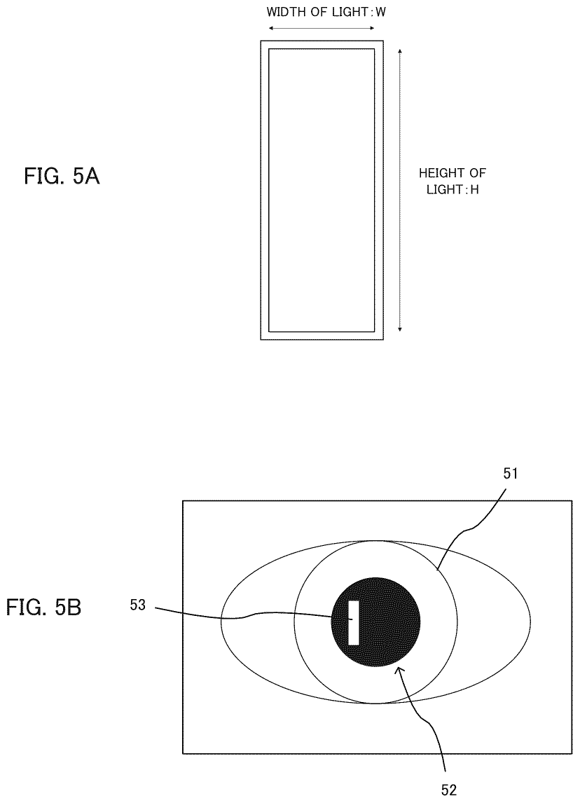

In the following, the image processing filter will be described in detail. As one example, the shape of the image processing filter is determined in advance based on the shape of the light 3. FIG. 5A illustrates one example of the light 3. In this example, the light 3 is a linear light source having a vertically long rectangular shape. FIG. 5B illustrates an example of a reflection region of the light appearing in the iris image. In the iris image in FIG. 5B, a reference numeral 51 denotes an iris, and a reference numeral 52 denotes a pupil. A reflection region 53 of the light 3 is appearing on the inside of the pupil 52. The reflection region 53 is formed by the light which is reflected by an eye ball surface.

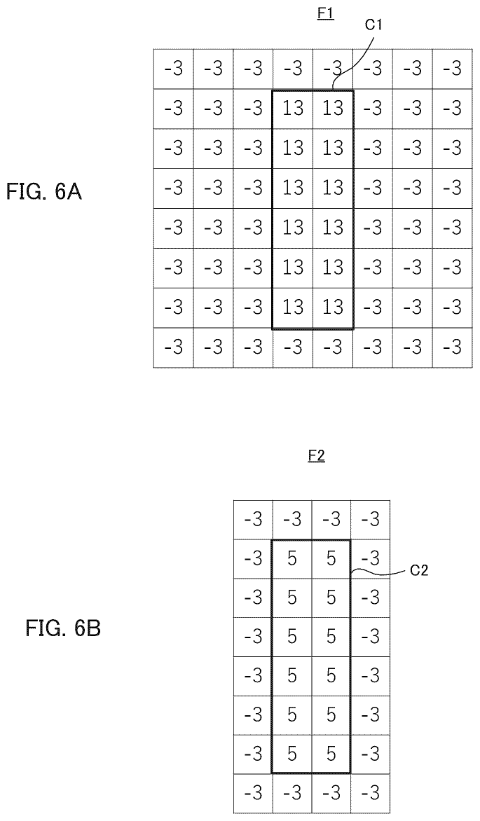

FIG. 6A illustrates an example of the image processing filter in a case of FIGS. 5A and 5B. In the image processing filter F1 illustrated in FIG. 6A, coefficients in a vertically long central region C1 are set larger than the other regions in correspondence with the shape of the light 3 illustrated in FIG. 5A. In a case where the shape of the image processing filter is decided based on the shape of the light 3, the shape of the image processing filter is decided in advance based on the shape of the light 3 which is actually used. The image processing filter decided in advance in such a manner is used for the focus determination of the iris images of plural users X. It is assumed that “a shape of a filter” represents a concept including a size of the filter and a coefficient value of each segment of the filter. For example, the shape of the image processing filter F1 in FIG. 6A includes a filter size of 8×8 pixels and a coefficient value of each segment forming the filter F1.

When the image processing filter as shown in FIG. 6A is applied to the iris image, in the iris image resulting from the filter processing, pixels values of the reflection region 53 of the light as illustrated in FIG. 5B become large. The focus determination device 100 performs the focus determination by using the reflection region 53 of the light. In a state where the image is in focus, in the iris image resulting from the filter processing, differences in the pixel value between the reflection region 53 of the light and regions around that become large. Thus, as the image is in better focus state, the pixel values in the reflection region 53 of the light become larger in the iris image resulting from the filter processing. Thus, in the iris image resulting from the filter processing, when there is a region whose pixel values are large and which corresponds to the reflection region 53 of the light, it can be determined that the iris image is in focus.

Further, as an image processing filter F2 illustrated in FIG. 6B, the size itself of the image processing filter may be formed into a shape based on the shape of the light 3. In the image processing filter F2, coefficients in a vertically long central region denoted by a reference character C2 are set large in accordance with the shape of the light 3. By reducing the size of the image processing filter, a decrease in a computation amount in the filter processing unit 102 can be expected.

Returning to FIG. 4, the iris image resulting from the filter processing by the filter processing unit 102 is inputted to the filter output integration unit 103. The filter output integration unit 103 uses, as an input, the iris image resulting from the filter processing by using the image processing filter (hereinafter, also referred to as “filter-processed image”), performs an integration process using the pixel values of the filter-processed image, and outputs a result value of integration as a filter output integration value P. Specifically, the filter output integration unit 103 outputs an average value of all pixel values of the filter-processed image as the filter output integration value P. Alternatively, the filter output integration unit 103 may divide the filter-processed image into plural local regions, calculate an average value of the pixel values for each of the local regions, and output the average values as the filter output integration value P. The filter output integration value P is a value which indicates a focused degree of the iris image, that is, an extent of focusing. The filter output integration unit 103 outputs the filter output integration value P to the focus determination unit 104.

The focus determination unit 104 compares the filter output integration value P with a threshold value Q decided in advance and thereby performs the focus determination of the iris image. Specifically, in a case where the filter output integration value P is equal to or larger than the threshold value Q, the focus determination unit 104 determines that the iris image is in focus. On the other hand, in a case where the filter output integration value P is smaller than the threshold value Q, the focus determination unit 104 determines that the iris image is out of focus. Note that in a case where the filter output integration unit 103 outputs the filter output integration value of each of the local regions, the focus determination unit 104 may determine that the iris image is in focus when the number of local regions having the filter output integration values equal to or larger than the threshold value Q is equal to or larger than a predetermined number, and may determine that the iris image is out of focus when the number of local regions having the filter output integration values equal to or larger than the threshold value Q is smaller than the predetermined number.

In the above configuration, the iris image acquisition unit 101 is one example of an acquisition unit, the filter processing unit 102 is one example of a filter processing unit, and the filter output integration unit 103 and the focus determination unit 104 are one example of a focus determination unit.

(Focus Determination Process)

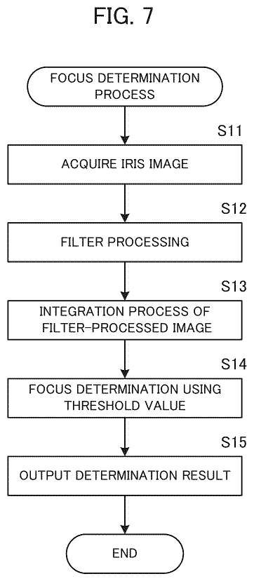

FIG. 7 is a flowchart of the focus determination process by the focus determination device 100 in the first example embodiment. The processor 12 illustrated in FIG. 3 executes programs prepared in advance and operates as elements illustrated in FIG. 4, and this process is thereby realized.

First, the iris image acquisition unit 101 acquires the iris image inputted from the camera 2 or the like and outputs it to the filter processing unit 102 (step S11). Next, the filter processing unit 102 executes the filter processing by applying the image processing filter prepared in advance to the iris image and outputs the filter-processed image to the filter output integration unit 103 (step S12). The filter output integration unit 103 performs the integration process using the pixel values of the filter-processed image and outputs the filter output integration value P to the focus determination unit 104 (step S13). The focus determination unit 104 performs the focus determination by comparing the filter output integration value P with the predetermined threshold value Q (step S14), and outputs a determination result (step S15). Then, the focus determination process ends.

As described above, in the first example embodiment, the filter processing is performed by using the image processing filter in the shape decided based on the shape of the light which is actually used when the iris image is taken, and the focus determination is performed. Thus, by using the shape of the actually used light as a reference, it becomes possible to precisely perform the focus determination.

### Second Example Embodiment

In the first example embodiment, the shape of the image processing filter is decided based on the shape of the light 3. Differently, in a second example embodiment, the shape of the image processing filter is decided in advance based on the shape of the reflection region of the light in the eye region of the iris image. Thus, since the image processing filter in the shape corresponding to the reflection region of the light can be obtained, the focus determination can be precisely performed. Note that except for this point, the second example embodiment is similar to the first example embodiment.

### Third Example Embodiment

In a third example embodiment, the shape of the image processing filter is decided such that the aspect ratio (length-to-width ratio) between the horizontal direction and the vertical direction of the light 3 agrees with the ratio between the magnitude in a lateral direction and the magnitude in a longitudinal direction of spatial frequency components of the image processing filter. Thus, since the image processing filter in the shape having the same length-to-width ratio as the light can be obtained, the focus determination can be precisely performed. Note that except for this point, the third example embodiment is similar to the first example embodiment.

### Fourth Example Embodiment

In a fourth example embodiment, the shape of the image processing filter is decided such that the aspect ratio (length-to-width ratio) between the horizontal direction and the vertical direction of the reflection region 53 of the light agrees with the ratio between the magnitude in the lateral direction and the magnitude in the longitudinal direction of the spatial frequency components of the image processing filter. In a case where the shape of the image processing filter is decided based on the shape of the reflection region of the light, the shape of the reflection region of the light is detected by using an image of the eye region which is experimentally imaged with irradiating the light, and the shape of the image processing filter may be decided based on the detected shape. Thus, since the image processing filter in the shape having the same length-to-width ratio as the reflection region of the light can be obtained, the focus determination can be precisely performed. Note that except for this point, the fourth example embodiment is similar to the first example embodiment.

### Fifth Example Embodiment

In a fifth example embodiment, the shape of the image processing filter is decided such that the ratio between the magnitudes of a spatial frequency component in the horizontal direction and of a spatial frequency component in the vertical direction of the light 3 agrees with the ratio between a spatial frequency component in the lateral direction and a spatial frequency component in the longitudinal direction of the image processing filter. Thus, since the image processing filter in the shape having the same length-to-width ratio as the light can be obtained, the focus determination can be precisely performed. Note that except for this point, the fifth example embodiment is similar to the first example embodiment.

### Sixth Example Embodiment

In a sixth example embodiment, the shape of the image processing filter is decided such that the ratio between the magnitudes of a spatial frequency component in the horizontal direction and of a spatial frequency component in the vertical direction of the reflection region 53 of the light 3 agrees with the ratio between the spatial frequency component in the lateral direction and the spatial frequency component in the longitudinal direction of the image processing filter. Thus, since the image processing filter in the shape having the same length-to-width ratio as the reflection region of the light can be obtained, the focus determination can be precisely performed. Note that except for this point, the sixth example embodiment is similar to the first example embodiment.

### Seventh Example Embodiment

In the above fifth and sixth example embodiments, the shape of the image processing filter is decided such that the ratio between the magnitudes of the spatial frequency component in the horizontal direction and of the spatial frequency component in the vertical direction of the light 3 or of the reflection region 53 of the light 53 agrees with the ratio between the spatial frequency component in the lateral direction and the spatial frequency component in the longitudinal direction of the image processing filter. However, the ratio between the spatial frequency components in the longitudinal direction and the lateral direction of the image processing filter may not have to strictly agree with the aspect ratio of the shape of the light 3 or the shape of the reflection region 53 of the light. In this point, in a seventh example embodiment, the shape of the image processing filter is decided such that the size relation of the lengths of the shape of the light 3 in the horizontal direction and in the vertical direction agrees with the size relation of the magnitude in the lateral direction and of the magnitude in the longitudinal direction of the spatial frequency components of the image processing filter. Thus, since the image processing filter in the shape whose longitudinal/lateral size relationship agrees with that of the light can be obtained, the focus determination can be performed by using a highly versatile image processing filter. Note that except for this point, the seventh example embodiment is similar to the first example embodiment.

### Eighth Example Embodiment

In the seventh example embodiment, the shape of the image processing filter is decided such that the size relation of the lengths of the shape of the light 3 in the horizontal direction and in the vertical direction agrees with the size relation of the magnitude in the lateral direction and of the magnitude in the longitudinal direction of the spatial frequency components of the image processing filter. Instead, in an eighth example embodiment, the shape of the image processing filter may be decided such that the size relation of the lengths of the shape of the reflection region 53 of the light in the horizontal direction and in the vertical direction agrees with the size relation of the magnitude in the lateral direction and of the magnitude in the longitudinal direction of the spatial frequency components of the image processing filter. Thus, since the image processing filter in the shape whose longitudinal/lateral size relation agrees with that of the reflection region of the light can be obtained, the focus determination can be performed by using a highly versatile image processing filter. Note that except for this point, the eighth example embodiment is similar to the first example embodiment.

### Ninth Example Embodiment

In the first to eighth example embodiments, the filter processing is performed by using the image processing filter which is prepared in advance based on the shape of the light or the shape of the reflection region of the light. That is, in the first to eighth example embodiments, a versatile image processing filter which is prepared in advance is applied to plural iris images inputted. Differently, in a ninth example embodiment, a reflection region of a light in an inputted iris image is detected to estimate the shape of the light, and the shape of the filter is decided based on the estimated shape.

(Hardware Configuration)

A hardware configuration of a focus determination device of the ninth example embodiment is similar to the focus determination device 100 of the first example embodiment which is illustrated in FIG. 3.

(Functional Configuration)

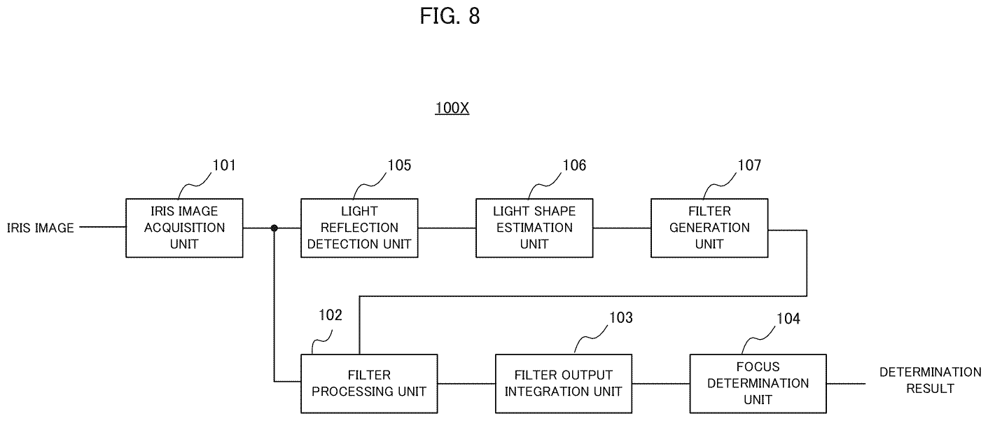

FIG. 8 is a block diagram illustrating a functional configuration of a focus determination device 100X according to the ninth example embodiment. The focus determination device 100X includes a light reflection detection unit 105, a light shape estimation unit 106, and a filter generation unit 107 in addition to the iris image acquisition unit 101, the filter processing unit 102, the filter output integration unit 103, and the focus determination unit 104 which are similar to the first example embodiment.

The light reflection detection unit 105 detects a reflection region of the light as illustrated by the reflection region 53 in FIG. 5B from the iris image acquired by the iris image acquisition unit 101. For example, the light reflection detection unit 105 detects a region of pixels having luminance values (brightness) equal to or larger than a predetermined value among the pixels of the iris image as the reflection region. Then, the light reflection detection unit 105 outputs the sizes of the detected reflection region in the longitudinal direction and the lateral direction to the light shape estimation unit 106.

The light shape estimation unit 106 estimates the shape of the light based on the sizes in the longitudinal direction and the lateral direction of the reflection region detected by the light reflection detection unit 105 and outputs a condition which defines the shape of the light to the filter generation unit 107. The condition which defines the shape of the light (hereinafter, also referred to as “light shape condition”) may be the ratio between the longitudinal and lateral lengths of the light (i.e., the aspect ratio) or may be a size relation between the longitudinal and lateral lengths of the light. In addition to those, the condition which defines the shape of the light may be a condition which defines the shape of the light such as a circular shape or a square.

The filter generation unit 107 decides the shape of the image processing filter to be used in the filter processing unit 102 based on the light shape condition inputted from the light shape estimation unit 106. That is, the filter generation unit 107 decides the shape of the image processing filter for extracting the shape defined by the inputted light shape condition and thereby generates the image processing filter. Note that as described above, the shape of the filter includes the size of the filter and the coefficient value of each segment of the filter.

Here, the filter generation unit 107 decides the shape of the image processing filter by a method similar to any one of the first to eighth example embodiments. That is, the filter generation unit 107 may decide the shape of the image processing filter such that the aspect ratio between the horizontal direction and the vertical direction of the light defined by the light shape condition agrees with the ratio between the magnitude in the lateral direction and the magnitude in the longitudinal direction of the spatial frequency components of the image processing filter. Alternatively, the filter generation unit 107 may decide the shape of the image processing filter such that the ratio between the magnitudes of the spatial frequency component in the horizontal direction and of the spatial frequency component in the vertical direction of the light defined by the light shape condition agrees with the ratio between the spatial frequency component in the lateral direction and the spatial frequency component in the longitudinal direction of the image processing filter. Further, the filter generation unit 107 may decide the shape of the image processing filter such that the size relation of the lengths in the horizontal direction and in the vertical direction of the shape of the light defined by the light shape condition agrees with the size relation of the magnitude in the lateral direction and of the magnitude in the longitudinal direction of the spatial frequency components of the image processing filter. The filter generation unit 107 outputs the generated image processing filter to the filter processing unit 102.

The operation of the filter processing unit 102, the filter output integration unit 103, and the focus determination unit 104 are similar to the first example embodiment. Note that the filter processing unit 102 applies the image processing filter generated by the filter generation unit 107 to the iris image inputted from the iris image acquisition unit 101 and thereby performs the filter processing.

In such a manner, in the ninth example embodiment, the filter processing is performed by using not a versatile image processing filter used for plural iris images but the image processing filter which is individually generated based on the reflection region of the light in the iris image which is a target of the focus determination. Thus, it becomes possible to perform the focus determination of individual iris images more precisely.

In the above configuration, the light reflection detection unit 105 is one example of a detection unit, the light shape estimation unit 106 is one example of an estimation unit, and the filter generation unit 107 is one example of a filter generation unit.

(Focus Determination Process)

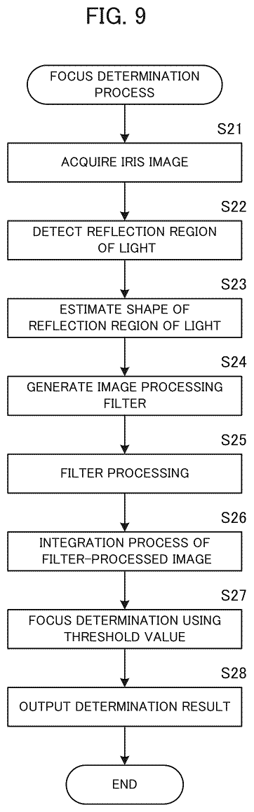

FIG. 9 is a flowchart of the focus determination process by the focus determination device 100X in the ninth example embodiment. The processor 12 illustrated in FIG. 3 executes programs prepared in advance and operates as elements illustrated in FIG. 8, and this process is thereby realized.

First, the iris image acquisition unit 101 acquires the iris image inputted from the camera 2 or the like and outputs it to the filter processing unit 102 and the light reflection detection unit 105 (step S21). The light reflection detection unit 105 detects the reflection region of the light on the eye ball surface from the inputted iris image and outputs the lengths in the longitudinal direction and the lateral direction of the detected reflection region of the light to the light shape estimation unit 106 (step S22). The light shape estimation unit 106 estimates the shape of the light based on the lengths of the inputted reflection region in the longitudinal direction and the lateral direction and outputs the light shape condition which defines the shape of the light to the filter generation unit 107 (step S23). The filter generation unit 107 decides the shape of the image processing filter based on the inputted light shape condition, generates the image processing filter, and outputs it to the filter processing unit 102 (step S24).

The filter processing unit 102 applies the image processing filter generated by the filter generation unit 107 to the iris image inputted from the iris image acquisition unit 101 and thereby performs the filter processing (step S25). The subsequent processes are basically similar to the first example embodiment. That is, the filter output integration unit 103 performs the integration process using the pixel values of the filter-processed image and outputs the filter output integration value P to the focus determination unit 104 (step S26). Next, the focus determination unit 104 performs the focus determination by comparing the filter output integration value P with the predetermined threshold value Q (step S27) and outputs a determination result (step S28). Then, the focus determination process ends.

As described above, in the ninth example embodiment, the image processing filter to be used for the focus determination of a certain iris image is generated based on the shape of the light which is detected from the iris image. Therefore, the focus determination can be performed highly precisely by using the image processing filter of the shape close to the shape of the reflection of the light included in each iris image.

### Tenth Example Embodiment

A tenth example embodiment is related to an iris authentication device which includes the focus determination device of any one of the first to ninth example embodiments. In the iris authentication, it is important to use an iris image in which the iris is in focus in order to capture a fine pattern of the iris. Generally, in order to take an image in which the iris is in focus, when the iris image is taken, a method is used in which plural images are taken while focus positions are changed. However, in a case where the iris authentication is performed by using the plural iris images taken, there is a problem that an authentication process takes time due to an increase in the number of the images to which the authentication process is applied. In the present example embodiment, the iris authentication is efficiently performed by using the focus determination device of any one of the first to ninth example embodiments.

(Hardware Configuration)

A hardware configuration of the iris authentication device according to the tenth example embodiment is basically similar to the focus determination device 100 of the first example embodiment illustrated in FIG. 3. However, it is assumed that the iris image as a target of the iris authentication and feature values of the iris (hereinafter, referred to as “iris feature values”) are registered in advance in the DB 15.

(Functional Configuration)

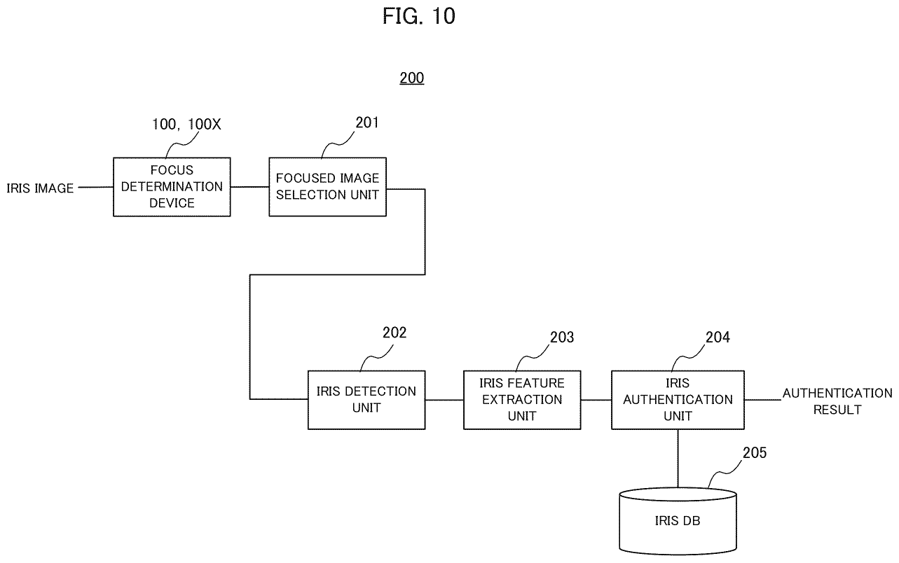

FIG. 10 is a block diagram illustrating a functional configuration of an iris authentication device 200 according to the tenth example embodiment. The iris authentication device 200 includes the focus determination device 100 according to any one of the first to eighth example embodiments or the focus determination device 100X according to the ninth example embodiment, a focused image selection unit 201, an iris detection unit 202, an iris feature extraction unit 203, an iris authentication unit 204, and an iris DB 205.

Plural iris images of the same person in different focus states are inputted to the focus determination device 100 or 100X. The focus determination device 100 or 100X performs the focus determination of the inputted iris images and outputs determination results of the plural inputted iris images to the focused image selection unit 201.

The focused image selection unit 201 outputs the iris image determined to be in focus (hereinafter, also referred to as “focused iris image”) among the plural iris images based on the determination results to the iris detection unit 202. The iris detection unit 202 detects an iris region from the focused iris image and outputs it to the iris feature extraction unit 203. The iris feature extraction unit 203 extracts the iris feature values from the iris region detected by the iris detection unit 202 and outputs the iris feature values to the iris authentication unit 204. Note that the iris feature extraction unit 203 extracts the iris feature values by using Daugman's algorithm or other arbitrary algorithms.

The iris DB 205 stores the iris images and the iris feature values for the persons whose iris information has already been registered. The iris authentication unit 204 collates the iris feature values inputted from the iris feature extraction unit 203 with the iris feature values of the person who has already been registered in the iris DB 205 and thereby performs the iris authentication. For example, in a case where a collation score between the iris feature values from the iris feature extraction unit 203 and the iris feature values of a certain person who has already been registered in the iris DB 205 is equal to or larger than a predetermined score, the iris authentication unit 204 determines that the person of the iris image is a person who has already been registered.

Note that the focus determination device 100 or 100X detects the reflection region of the light by performing the filter processing. However, usually, halation occurs to the pixel values of the reflection region of the light, and the reflection region is unsuitable for authentication of feature values. Therefore, it is preferable that the iris authentication unit 204 do not use the reflection region of the light for authentication, or lower the weights of the reflection region of the light in the authentication so that the reflection region of the light is unlikely to be reflected in the score. Then, the iris authentication unit 204 outputs an authentication result.

In the above configuration, the focused image selection unit 201 is one example of an image selection unit, the iris detection unit 202 is one example of an iris detection unit, the iris feature extraction unit 203 is one example of a feature values extraction unit, and the iris authentication unit 204 is one example of an iris authentication unit.

As described above, the iris authentication device 200 of the tenth example embodiment extracts the focused iris image from plural iris images of the same person by the focus determination process and can thereby perform the iris authentication process. Therefore, an iris detection process, an iris feature extraction process, and the iris authentication process can be omitted for the iris images which are out of focus, and it becomes possible to reduce the calculation amount and to shorten a processing time in the iris authentication process. In addition, by removing the images which are out of focus in advance, the iris images which are blurry and unsuitable for authentication can be prevented from being used for the iris authentication process, and it becomes possible to reduce an occurrence of false authentication.

### Eleventh Example Embodiment

An eleventh example embodiment is also related to an iris authentication device which includes the focus determination device of any one of the first to ninth example embodiments. Usually, when the iris image is taken, the user stops in front of an imaging device as illustrated as an example in FIGS. 1A and 1B. Differently, there is proposed a method in which a camera is provided to a security gate or the like, and the iris image of a user walking thereto is taken to perform the iris authentication. This method is referred to as walk-through iris authentication or the like. In a case of the walk-through iris authentication, since the user moves, the shape of the reflection region of the light changes in time series. In this case, when the focus determination process of the first to ninth example embodiments is applied to all iris images taken in time series, a processing amount becomes huge. Accordingly, in the eleventh example embodiment, the iris image in the focused state is efficiently extracted from a large number of iris images, and the iris authentication is thereby performed.

(Hardware Configuration)

A hardware configuration of the iris authentication device according to the eleventh example embodiment is basically similar to the focus determination device 100 of the first example embodiment illustrated in FIG. 3. However, the DB 15 stores the iris images and the iris feature values of the persons who have already been registered.

(Functional Configuration)

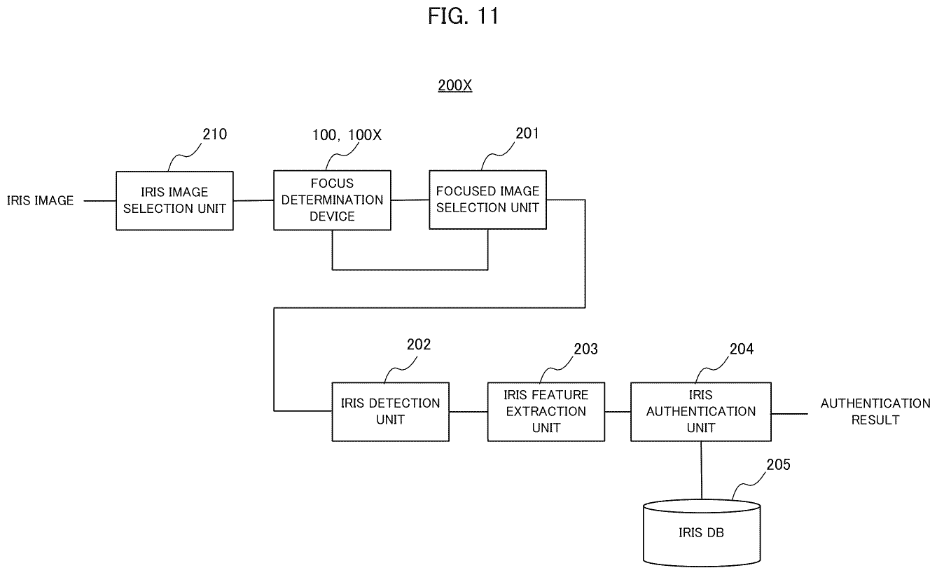

FIG. 11 is a block diagram illustrating a functional configuration of an iris authentication device 200X according to the eleventh example embodiment. The iris authentication device 200X includes an iris image selection unit 210 in addition to the configuration of the iris authentication device 200 according to the tenth example embodiment.

To the iris image selection unit 210, a large number of iris images, which are taken for the same person by a walk-through iris authentication system or the like, are inputted. The iris image selection unit 210 selects, as determination target images, a portion of the iris images among the large number of inputted iris images and outputs those to the focus determination device 100 or 100X. The focus determination device 100 or 100X performs the focus determination of the inputted determination target images and outputs determination results to the focused image selection unit 201. The focused image selection unit 201 selects the iris images which are in focus based on the determination results of the determination target images and outputs them to the iris detection unit 202. Alternatively, in a case where the number of the determination target images whose filter output integration values P exceed the predetermined threshold value Q is equal to or larger than a predetermined number, the focused image selection unit 201 may again apply the focus determination process to those iris images, thereby to extract a predetermined number of iris images in good focus state, and output them to the iris detection unit 202. Note that processes by the iris detection unit 202, the iris feature extraction unit 203, and the iris authentication unit 204 are similar to the tenth example embodiment, and descriptions thereof will be omitted.

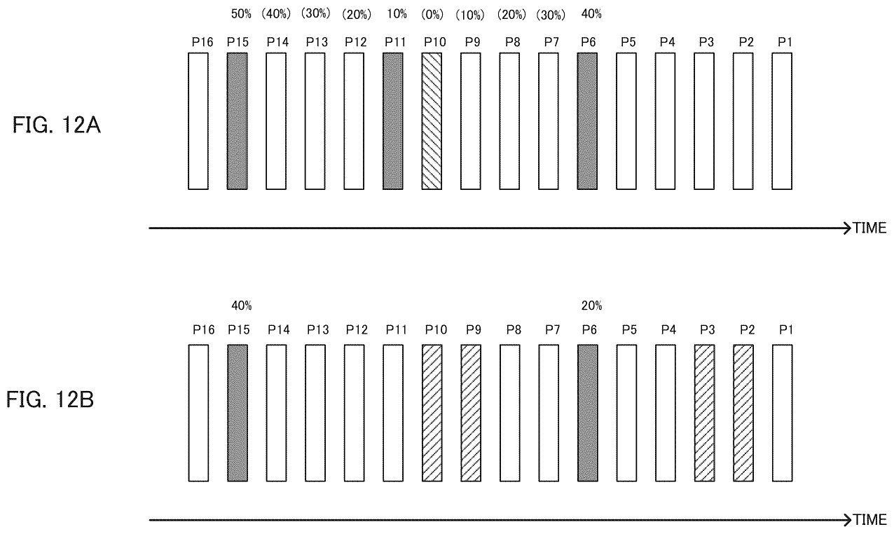

Next, a detailed description will be given of a selection method of iris images by the iris image selection unit 210. FIG. 12A illustrates an example of the selection method of images by the iris image selection unit 210 in the eleventh example embodiment. FIG. 12A schematically illustrates plural iris images P1 to P16 which are taken in time series. The iris image selection unit 210 selects plural arbitrary images from the plural iris images P1 to P16. For example, the iris image selection unit 210 selects three iris images P6, P11, and P15 in FIG. 12A and outputs those to the focus determination device 100 or 100X. The focus determination device 100 or 100X performs the focus determination of the iris images P6, P11, and P15 and outputs determination results to the focused image selection unit 201.

Here, it is assumed that focus deviation degrees of the iris images P6, P11, and P15 with respect to the threshold value Q as a reference are 40%, 10%, and 50%, respectively. Supposing that the moving speed of the user is constant, the focus deviation degrees of the iris images P7 to P10 and P12 to P14 can be estimated to be the values indicated in the parentheses in FIG. 12A. Therefore, the focused image selection unit 201 selects the iris image P10 as the focused iris image and outputs it to the iris detection unit 202. Note that instead of deciding the iris image P10 as the focused iris image, the focused image selection unit 201 may input the iris images P7 to P10 to the focus determination device 100 or 100X, cause the focus determination device 100 or 100X to again perform the focus determination, and decide the focused iris image from the determination results.

In a case where the focused iris image decided as described above is an image having a relatively large halation portion caused by the light, the iris image is not suitable for authentication even though it is in focus. Accordingly, as for the focused iris image decided in the above method, the iris image selection unit 210 may determine whether the size of the reflection region of the light or the size of a portion of the reflection region which overlaps with the iris is equal to or larger than a predetermined value. In a case where the size is equal to or larger than the predetermined value, the iris image selection unit 210 may again select, as an image to be used for authentication, an image among previous and subsequent images of the above focused iris image, whose focus state is in an allowable level for authentication even if it is somewhat out of focus and whose size of the reflection region of the light is small.

Further, in the above method, after taking the iris images of a moving user, an iris image in a good focus state and suitable for authentication is selected from plural iris images. However, instead of that, there is a method repeatedly performing the focus determination of plural iris images taken every time a user moves a predetermined distance. In this case, the filter processing and the focus determination process are performed for plural iris images taken when the user is present at a certain distance, and if an iris image which is in focus and suitable for authentication is obtained, the process is finished. On the other hand, if an iris image which is in focus cannot be obtained or if only an iris image is obtained which is in focus but is unsuitable for authentication due to the halation or the like in the reflection region of the light, the work of taking plural iris images while the user moves the next predetermined distance and selecting an iris image which is in focus and suitable for authentication is repeated.

As described above, even in a case where a large number of iris images are taken by the walk-through iris authentication system or the like, the iris authentication device 200X of the eleventh example embodiment selects an iris image which is in focus by performing the focus determination of only a portion of the iris images and can thereby efficiently carry out the iris authentication.

### Twelfth Example Embodiment

Similarly to the eleventh example embodiment, a twelfth example embodiment is applied to a case where a large number of iris images are taken by the walk-through iris authentication system or the like. However, the twelfth example embodiment is different from the eleventh example embodiment in the selection method of the iris image by the iris image selection unit 210. FIG. 12B illustrates an example of a selection method of images by the iris image selection unit 210 in the twelfth example embodiment. FIG. 12B schematically illustrates plural iris images P1 to P16 which are taken in time series. The iris image selection unit 210 selects plural arbitrary images from the plural iris images P1 to P16. For example, the iris image selection unit 210 selects two iris images P6 and P15 in FIG. 12B and outputs them to the focus determination device 100 or 100X. The focus determination device 100 or 100X performs the focus determination of the iris images P6 and P15 and outputs determination results to the focused image selection unit 201.

Here, it is assumed that the focus deviation degrees of the iris images P6 and P15 with respect to the threshold value Q as the reference are 20% and 40%. Supposing that the moving speed of the user is constant, it can be inferred that any one of the iris images P2, P3, P9, and P10, which are apart from the iris image P6 at a deviation degree of 20% by predetermined distances, is in the focused state. Thus, the focused image selection unit 201 inputs the iris images P2, P3, P9, and P10 to the focus determination device 100 or 100X, causes the focus determination device 100 or 100X to again perform the focus determination, and decides the focused iris image from the determination results.

As described above, even in a case where a large number of iris images are taken by the walk-through iris authentication system or the like, the iris authentication device 200X of the twelfth example embodiment selects an iris image which is in focus by performing the focus determination of only a portion of the iris images and can thereby efficiently carry out the iris authentication.

### Thirteenth Example Embodiment

A thirteenth example embodiment is also related to an iris authentication device which includes the focus determination device of any one of the first to ninth example embodiments. When the iris image is taken, usually, an iris of a user is irradiated with light. However, in a case where a user whose iris image is taken wears a device covering the eyes such as glasses, reflection by lenses or a frame of the glasses enters a taken image. When an iris image including reflection by lenses or a frame of glasses is used, it may falsely be determined that the iris is in focus due to an edge of the reflection by the lenses or the frame of the glasses in the focus determination, although the iris is actually out of focus. Accordingly, in the thirteenth example embodiment, the focus determination device 100 or 100X performs the focus determination of an iris image (hereinafter, referred to as “eyewear wearing image”) taken in a state where a user wears a device covering the eyes (hereinafter, referred to as “eyewear”) such as glasses, but does not perform the focus determination of an iris image (hereinafter, referred to as “eyewear non-wearing image”) taken in a state where a user does not wear an eyewear. Note that the eyewear includes sunglasses, goggles, and so forth in addition to glasses.

(Hardware Configuration)

A hardware configuration of the iris authentication device according to the thirteenth example embodiment is basically similar to the configuration of the focus determination device 100 of the first example embodiment which is illustrated in FIG. 3. However, the DB 15 stores the iris images and the iris feature values of the persons who have already been registered.

(Functional Configuration)

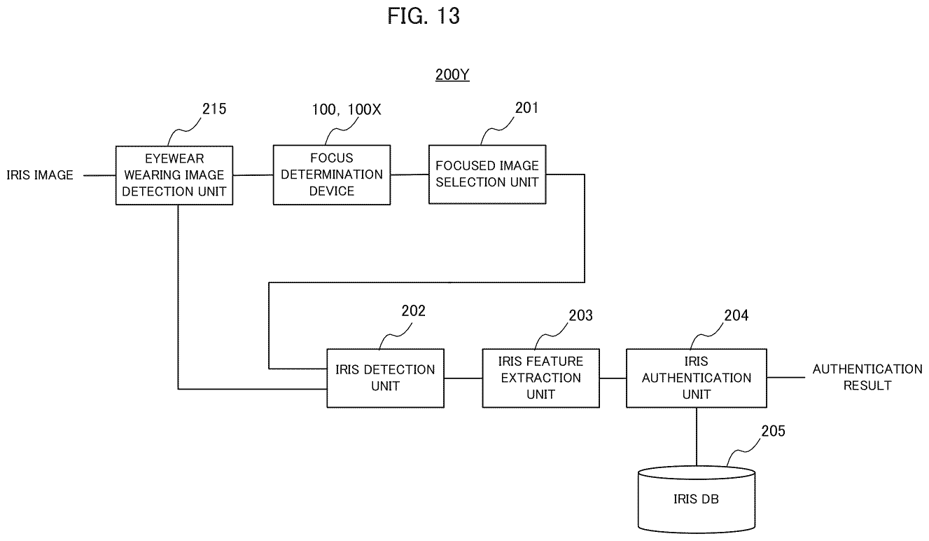

FIG. 13 is a block diagram illustrating a functional configuration of an iris authentication device 200Y according to the thirteenth example embodiment. The iris authentication device 200Y includes an eyewear wearing image detection unit 215 in addition to the configuration of the iris authentication device 200 according to the tenth example embodiment.

To the eyewear wearing image detection unit 215, plural iris images are inputted. The eyewear wearing image detection unit 215 detects eyewear wearing images from the inputted iris images. Note that the eyewear wearing image detection unit 215 may detect the eyewear wearing images based on colors or the like of the iris images. Further, in a case where the iris image includes a whole eyewear, the eyewear itself may be detected by image processing. The eyewear wearing image detection unit 215 outputs the eyewear wearing images to the focus determination device 100 or 100X and outputs eyewear non-wearing images to the iris detection unit 202. The focus determination device 100 or 100X performs the focus determination of the eyewear wearing images, and the focused image selection unit 201 selects the iris images in the focused state among the eyewear wearing images and outputs them to the iris detection unit 202. Thus, the iris images in the focused state among the eyewear wearing images and the eyewear non-wearing images are inputted to the iris detection unit 202. Note that the processes by the iris detection unit 202, the iris feature extraction unit 203, and the iris authentication unit 204 are similar to the tenth example embodiment, and descriptions thereof will be omitted.

In the thirteenth example embodiment, instead of performing the focus determination of the iris images of all users, the focus determination is performed only for the iris images of users wearing the eyewear. Thus, the focus determination and the iris authentication can efficiently be executed.

### Fourteenth Example Embodiment

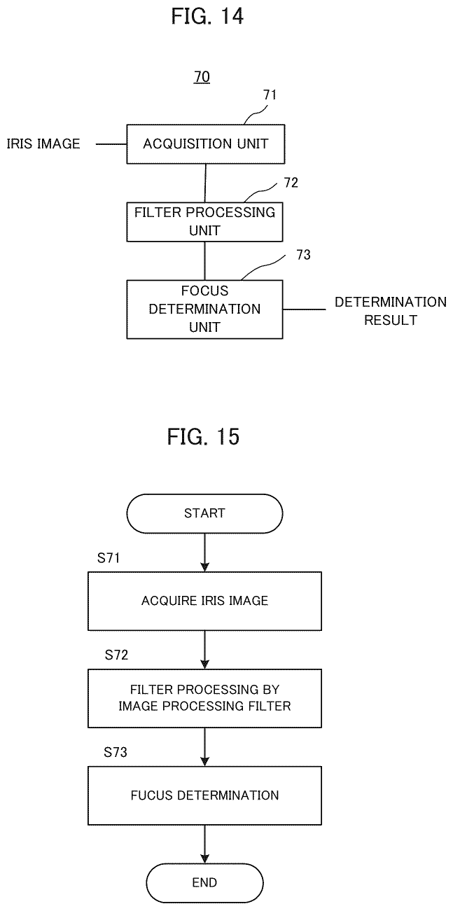

Next, a fourteenth example embodiment of the present disclosure will be described. FIG. 14 is a block diagram illustrating a functional configuration of a focus determination device according to the fourteenth example embodiment. A focus determination device 70 includes an acquisition unit 71, a filter processing unit 72, and a focus determination unit 73. The acquisition unit 71 acquires an iris image including an iris of a user. The filter processing unit 72 performs a filter processing by applying an image processing filter in a shape decided based on a shape of a light applied to the user to the iris image. The focus determination unit 73 determines whether or not the iris image is in focus based on the iris image resulting from the filter processing.

FIG. 15 is a flowchart of a focus determination process of the fourteenth example embodiment. The acquisition unit 71 acquires an iris image including an iris of a user (step S71). The filter processing unit 72 performs a filter processing by applying an image processing filter in a shape decided based on a shape of a light applied to the user to the iris image (step S72). The focus determination unit 73 determines whether or not the iris image is in focus based on the iris image resulting from the filter processing (step S73).

In the fourteenth example embodiment, since a focus state of the iris image is determined by using the shape of the light used when the iris image is taken, it becomes possible to precisely determine the focus state based on a known shape.

A part or all of the above example embodiments may also be described as the following supplementary notes, but not limited thereto.

(Supplementary Note 1)

A focus determination device comprising:
an acquisition unit configured to acquire an iris image including an iris of a user;
a filter processing unit configured to perform a filter processing by applying an image processing filter in a shape decided based on a shape of a light applied to the user to the iris image; and
a focus determination unit configured to determine whether or not the iris image is in focus based on the iris image resulting from the filter processing.

(Supplementary Note 2)

The focus determination device according to supplementary note 1,
wherein the shape of the image processing filter is decided in advance based on the shape of the light.

(Supplementary Note 3)

The focus determination device according to supplementary note 2,
wherein the shape of the image processing filter is decided such that an aspect ratio between a horizontal direction and a vertical direction of the light agrees with a ratio between a magnitude in a lateral direction and a magnitude in a longitudinal direction of spatial frequency components of the image processing filter.

(Supplementary Note 4)

The focus determination device according to supplementary note 2,
wherein the shape of the image processing filter is decided such that a ratio between magnitudes of a spatial frequency component in a horizontal direction and of a spatial frequency component in a vertical direction of the light agrees with a ratio between a spatial frequency component in a lateral direction and a spatial frequency component in a longitudinal direction of the image processing filter.

(Supplementary Note 5)

The focus determination device according to supplementary note 2,
wherein the shape of the image processing filter is decided such that a size relation of lengths in a horizontal direction and in a vertical direction of the light agrees with a size relation of a magnitude in a lateral direction and of a magnitude in a longitudinal direction of spatial frequency components of the image processing filter.

(Supplementary Note 6)

The focus determination device according to supplementary note 1,
wherein the shape of the image processing filter is decided in advance based on a shape of a reflection region of the light in the iris image.

(Supplementary Note 7)

The focus determination device according to supplementary note 6,
wherein the shape of the image processing filter is decided such that an aspect ratio of the shape of the reflection region in a horizontal direction and a vertical direction agrees with a ratio between a magnitude in a lateral direction and a magnitude in a longitudinal direction of spatial frequency components of the image processing filter.

(Supplementary Note 8)

The focus determination device according to supplementary note 6,
wherein the shape of the image processing filter is decided such that a ratio between magnitudes of a spatial frequency component in a horizontal direction and of a spatial frequency component in a vertical direction of the shape of the reflection region agrees with a ratio between a spatial frequency component in a lateral direction and a spatial frequency component in a longitudinal direction of the image processing filter.

(Supplementary Note 9)

The focus determination device according to supplementary note 6,
wherein the shape of the image processing filter is decided such that a size relation of lengths in a horizontal direction and in a vertical direction of the shape of the reflection region agrees with a size relation of a magnitude in a lateral direction and of a magnitude in a longitudinal direction of spatial frequency components of the image processing filter.

(Supplementary Note 10)

The focus determination device according to supplementary note 1, further comprising:
a detection unit configured to detect a reflection region of the light from the iris image;
an estimation unit configured to estimate the shape of the light based on a shape of the reflection region; and
a filter generation unit configured to decide the shape of the image processing filter based on the estimated shape of the light.

(Supplementary Note 11)

An iris authentication device comprising:
an image selection unit configured to select a focused iris image from plural iris images by using the focus determination device according to any one of Supplementary notes 1 to 10;
an iris detection unit configured to detect an iris region from the focused iris image;
a feature extraction unit configured to extract a feature value from the detected iris region; and
an iris authentication unit configured to perform iris authentication by using the extracted feature value.

(Supplementary Note 12)

The iris authentication device according to supplementary note 11,
wherein the image selection unit selects, as determination target images, a portion of the iris images among the plural iris images, performs a focus determination of the determination target images by using the focus determination device, and selects the focused iris image based on a determination result.

(Supplementary Note 13)

The iris authentication device according to supplementary note 11,
wherein the image selection unit selects, as determination target images, a portion of the iris images among the plural iris images, performs a focus determination of the determination target images by using the focus determination device, decides next determination target images based on a determination result, and selects the focused iris image based on the determination result of the next determination target images.

(Supplementary Note 14)

An iris authentication device comprising:
an eyewear wearing image detection unit configured to detect an iris image, which is taken in a state where an eyewear is worn, from the plural iris images;
an image selection unit configured to select a focused iris image from the plural iris images, which are taken in a state where an eyewear is worn, by using the focus determination device according to any one of Supplementary notes 1 to 10;
an iris detection unit configured to detect an iris region from an iris image which is taken in a state where an eyewear is not worn and the focused iris image selected by the image selection unit;
a feature extraction unit configured to extract a feature value from the detected iris region; and
an iris authentication unit configured to perform iris authentication by using the extracted feature value.

(Supplementary Note 15)

A focus determination method comprising:
acquiring an iris image including an iris of a user;
performing a filter processing by applying an image processing filter in a shape decided based on a shape of a light irradiated to the user to the iris image; and determining whether or not the iris image is in focus based on the iris image resulting from the filter processing.

(Supplementary Note 16)

A recording medium recording a program causing a computer to execute the processes of:
acquiring an iris image including an iris of a user;
performing a filter processing by applying an image processing filter in a shape decided based on a shape of a light irradiated to the user to the iris image; and
determining whether or not the iris image is in focus based on the iris image resulting from the filter processing.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1 Imaging device
2 Camera
3 Light
12 Processor
100, 100X Focus determination device
101 Iris image acquisition unit
102 Filter processing unit
103 Filter output integration unit
104 Focus determination unit
105 Light reflection detection unit
106 Light shape estimation unit
107 Filter generation unit
200, 200X, 200Y Iris authentication device
201 Focus image selection unit
202 Iris detection unit
203 Iris feature extraction unit
204 Iris authentication unit
205 Iris DB

What is claimed is:

1. A focus determination device comprising:
a memory configured to store instructions; and
one or more processors configured to execute the instructions to:
acquire an iris image including an iris of a user;
perform a filter processing by applying an image processing filter in a shape decided based on a shape of a light applied to the user to the iris image; and
determine whether or not the iris image is in focus based on the iris image resulting from the filter processing.

2. The focus determination device according to claim 1,
wherein the shape of the image processing filter is decided in advance based on the shape of the light.

3. The focus determination device according to claim 2,
wherein the shape of the image processing filter is decided such that an aspect ratio between a horizontal direction and a vertical direction of the light agrees with a ratio between a magnitude in a lateral direction and a magnitude in a longitudinal direction of spatial frequency components of the image processing filter.

4. The focus determination device according to claim 2,
wherein the shape of the image processing filter is decided such that a ratio between magnitudes of a spatial frequency component in a horizontal direction and of a spatial frequency component in a vertical direction of the light agrees with a ratio between a spatial frequency component in a lateral direction and a spatial frequency component in a longitudinal direction of the image processing filter.

5. The focus determination device according to claim 2,
wherein the shape of the image processing filter is decided such that a size relation of lengths in a horizontal direction and in a vertical direction of the light agrees with a size relation of a magnitude in a lateral direction and of a magnitude in a longitudinal direction of spatial frequency components of the image processing filter.

6. The focus determination device according to claim 1,
wherein the shape of the image processing filter is decided in advance based on a shape of a reflection region of the light in the iris image.

7. The focus determination device according to claim 6,
wherein the shape of the image processing filter is decided such that an aspect ratio of the shape of the reflection region in a horizontal direction and a vertical direction agrees with a ratio between a magnitude in a lateral direction and a magnitude in a longitudinal direction of spatial frequency components of the image processing filter.

8. The focus determination device according to claim 6,
wherein the shape of the image processing filter is decided such that a ratio between magnitudes of a spatial frequency component in a horizontal direction and of a spatial frequency component in a vertical direction of the shape of the reflection region agrees with a ratio between a spatial frequency component in a lateral direction and a spatial frequency component in a longitudinal direction of the image processing filter.

9. The focus determination device according to claim 6,
wherein the shape of the image processing filter is decided such that a size relation of lengths in a horizontal direction and in a vertical direction of the shape of the reflection region agrees with a size relation of a magnitude in a lateral direction and of a magnitude in a longitudinal direction of spatial frequency components of the image processing filter.

10. The focus determination device according to claim 1, wherein the one or more processors are further configured to execute the instructions to:
detect a reflection region of the light from the iris image;
estimate the shape of the light based on a shape of the reflection region; and
decide the shape of the image processing filter based on the estimated shape of the light.

11. An iris authentication device comprising:
an additional memory configured to store instructions; and
one or more additional processors configured to execute the instructions to:
select a focused iris image from plural iris images by using the focus determination device according to claim 1;
detect an iris region from the focused iris image;
extract a feature value from the detected iris region; and
perform iris authentication by using the extracted feature value.

12. The iris authentication device according to claim 11, wherein the one or more additional processors select, as determination target images, a portion of the iris images among the plural iris images, performs a focus determination of the determination target images by using the focus determination device, and selects the focused iris image based on a determination result.

13. The iris authentication device according to claim 11, wherein the one or more additional processors select, as determination target images, a portion of the iris images among the plural iris images, performs a focus determination of the determination target images by using the focus determination device, decides next determination target images based on a determination result, and selects the focused iris image based on the determination result of the next determination target images.

14. An iris authentication device comprising:
an additional memory configured to store instructions; and
one or more additional processors configured to execute the instructions to:
detect an iris image, which is taken in a state where an eyewear is worn, from the plural iris images;
select a focused iris image from the plural iris images, which are taken in a state where an eyewear is worn, by using the focus determination device according to claim 1;
detect an iris region from an iris image which is taken in a state where an eyewear is not worn and the focused iris image selected;
extract a feature value from the detected iris region; and
perform iris authentication by using the extracted feature value.

15. A focus determination method comprising:
acquiring an iris image including an iris of a user;
performing a filter processing by applying an image processing filter in a shape decided based on a shape of a light irradiated to the user to the iris image; and
determining whether or not the iris image is in focus based on the iris image resulting from the filter processing.

16. A non-transitory computer-readable recording medium recording a program causing a computer to execute the processes of:
acquiring an iris image including an iris of a user;
performing a filter processing by applying an image processing filter in a shape decided based on a shape of a light irradiated to the user to the iris image; and
determining whether or not the iris image is in focus based on the iris image resulting from the filter processing.
